(19) United States
(12) Patent Application Publication
(10) Pub. No.: US 2026/0066255 A1
(43) Pub. Date: Mar. 5, 2026

(54) ION SOURCE

(71) Applicant: Micromass UK Limited, Wilmslow (GB)

(72) Inventors: Christopher Wheeldon, Glossop (GB); Nicholas Smith, Chester (GB); Ian David Trivett, Cheadle (GB); Jakub Ujma, Macclesfield (GB)

(21) Appl. No.: 19/292,555

(22) Filed: Aug. 6, 2025

Related U.S. Application Data
(60) Provisional application No. 63/691,120, filed on Sep. 5, 2024.

(30) Foreign Application Priority Data
Sep. 12, 2024 (GB) 2413427.2

(51) Int. Cl. H01J 49/16; G01N 27/623

(52) U.S. Cl. CPC H01J 49/165; G01N 27/623

(57) ABSTRACT

An ion source is disclosed that comprises a positioning assembly that can position a sprayer with respect to an ion inlet. The ion source includes a first imaging device that can provide a first view of a position of the sprayer with respect to the ion inlet, and a second imaging device that can provide a second, different view of a position of the sprayer with respect to the ion inlet. The second view has a higher magnification than the first view.

### CROSS-REFERENCE TO RELATED APPLICATION

This application claims priority from and the benefit of U.S. Provisional Ser. No. 63/691,120 filed on Sep. 5, 2024, and United Kingdom Patent Application No. 2413427.2 filed on Sep. 12, 2024, the entire contents of which are incorporated herein by reference.

### FIELD

The present disclosure relates to analytical instruments and ion sources, and in particular to electrospray ionisation (ESI) for mass and/or ion mobility spectrometry.

### BACKGROUND

A mass spectrometer is an analytical instrument that typically comprises an ion source for generating ions from an analytical sample, and a mass analyser for analysing the ions, or ions derived therefrom, to determine their mass to charge ratio.

In charge detection mass spectrometry (CDMS), the charge and mass to charge ratio of an ion are detected and used to determine its mass. CDMS is a useful technique that enables, for example, the characterisation of large, highly-charged and heterogeneous analytes, such as whole virus capsids, that are of increasing importance in biotherapeutics.

To effectively ionise such analytes, an electrospray ionisation (ESI) ion source may be used. Electrospray ionisation (ESI) is an ionisation technique where ions are generated or released from charged droplets generated via an electrospray process. Electrospraying can be carried out by liquid forming an interface with air at the tip of an emitter and electrostatic stress generated by electrification of the liquid via an applied voltage causing charged droplets to be emitted from the liquid interface. This process typically occurs in an atmospheric pressure chamber that contains an ion inlet aperture to the spectrometer.

### SUMMARY

An aspect comprises an ion source comprising:
a positioning assembly configured to position a sprayer with respect to an ion inlet;
a first imaging device configured to provide a first view of a position of the sprayer with respect to the ion inlet; and
a second imaging device configured to provide a second, different view of a position of the sprayer with respect to the ion inlet;
wherein the second view has a higher magnification than the first view.

Embodiments relate to an ion source, e.g. electrospray ionisation (ESI) ion source, for an analytical instrument, such as a mass spectrometer and/or ion mobility spectrometer, e.g. a charge detection mass spectrometer. In embodiments, the ion source comprises a sprayer, e.g. ESI sprayer, that generates a spray, e.g. of charged droplets, from an outlet/tip. In embodiments, ions generated by the sprayer/ion source pass through the ion inlet and are analysed by the analytical instrument.

The ion source comprises a positioning assembly configured to position the sprayer relative to the ion inlet, e.g. such that the position of the outlet of the sprayer relative to the ion inlet can be adjusted, e.g. to increase/optimise a number of ions passing through the ion inlet for analysis. The ion source further comprises first and second imaging devices, e.g. cameras, that are configured to provide respective different views (images) of a position of the sprayer/outlet relative to the ion inlet.

As will be discussed in more detail below, providing at least two different views of the position of the sprayer/outlet with respect to the ion inlet can improve the ease and accuracy of positioning the sprayer with respect to the ion inlet. This can increase the number of ions passing through the ion inlet for analysis, and thus improve duty cycle, for example.

Furthermore, the second view has a higher magnification than the first view. As will also be discussed in more detail below, this can further improve the ease and accuracy of positioning the sprayer with respect to the ion inlet.

Another aspect comprises an analytical instrument comprising the ion source. The analytical instrument may comprise an analyser configured to analyse ions generated by the ion source that may pass through the ion inlet, e.g. to determine their mass, charge, mass to charge ratio, ion mobility, and/or other physico-chemical property. The analyser may be a mass analyser and/or ion mobility analyser. Correspondingly, the analytical instrument may be a mass spectrometer and/or ion mobility spectrometer. The analyser may be a charge detection mass analyser. The analytical instrument may be a charge detection mass spectrometer.

The ion source may comprise an enclosure/chamber, e.g. an atmospheric pressure chamber, that contains the ion inlet aperture through which ions generated by the ion source pass to be analysed by the analyser.

The ion source may be configured to ionise a sample by the sprayer generating a spray comprising the sample. The sprayer may comprise a capillary through which liquid comprising sample may pass, and a voltage source/supply configured to apply a voltage to the capillary and/or sample. The voltage may cause sample to be electrosprayed from an outlet/tip of the capillary. The spray may be a spray of charged droplets. The sprayer may be configured to generate a spray that may comprise sample within the enclosure. The ion source may be an electrospray ionisation (ESI) ion source. One or more elements of the sprayer, such as the capillary and/or emitter tip, may be replaceable, e.g. user-replaceable.

The sprayer may comprise a manifold assembly and an emitter assembly. The emitter assembly may be removably attachable to the manifold assembly, e.g. and thereby replaceable. The emitter assembly may comprise a connector element that is removably attachable to a complementary connector element of the manifold assembly. The emitter assembly may comprise the capillary. The emitter assembly may comprise an electrode for causing electrospray from the outlet of the capillary, e.g. in the form of a sheath electrode that surrounds the capillary.

The manifold assembly may comprise one or more conduits for supplying and/or removing sprayer fluids, e.g. comprising sample. The one or more conduits may be in fluid communication with the capillary of the emitter assembly when the emitter assembly is attached to the manifold assembly. Similarly, one or more voltage supply elements of the emitter assembly and the manifold assembly may be in electrical communication with each other when the emitter assembly is attached to the manifold assembly. The manifold assembly may be attached to and positioned by the positioning assembly, and the emitter assembly may be removably attached to the manifold assembly.

The positioning assembly should, and in embodiments does, allow the position of the sprayer/outlet to be adjusted with respect to the ion inlet, e.g. by a user. The positioning assembly may be configured to adjustably position the sprayer in one or two dimensions. The positioning assembly may be configured to adjustably position the sprayer in three dimensions, e.g. corresponding to three orthogonal axes (X, Y, Z). The positioning assembly may comprise a multi-axis translation stage, e.g. three-axis translation stage, for adjustably positioning the sprayer along multiple, e.g. three, axes (e.g. X, Y, Z). The manifold assembly may be attached to and positioned by the multi-axis translation stage, and the emitter assembly may be removably attached to the manifold assembly.

The first and second imaging devices should be, and in embodiments are, configured to obtain images that show where the sprayer/outlet is positioned with respect to the ion inlet, and that may be used, e.g. by a user, to determine where the sprayer/outlet is positioned with respect to the ion inlet when adjusting the position of the sprayer using the positioning assembly. The first and second views should thus, and in embodiments do, comprise (two-dimensional) images that show the sprayer/outlet and the ion inlet, and their relative positions.

An or each imaging device may be a camera that comprises a lens and an image sensor, e.g. a digital image sensor, such as a CCD image sensor. An or each imaging device may comprise a light source for illuminating the sprayer/outlet and the ion inlet. An or each imaging device may comprise a mirror configured to turn (reflect) an optical path of the (respective) imaging device through an angle of ≥10 degrees, such as ≥20 degrees, such as ≥45 degrees, such as ≥80 degrees, such as about 90 degrees. For example, the mirror may be oriented at an angle of about 45 degrees with respect to an optical path passing through the (respective) camera lens.

The second view has a higher magnification than the first view. The lens of the second imaging device may have a higher magnification than the lens of the first imaging device. The first view may have a larger field of view than the second view. The first view may thus provide an overview of the position of the sprayer with respect to the ion inlet, and the second view may provide a more detailed view of the position of the sprayer with respect to the ion inlet.

The first view and the second view may be substantially orthogonal to each other. The first imaging device and the second imaging device may be arranged substantially orthogonal to each other, e.g. such that an optical path of the first imaging device is substantially orthogonal to an optical path of the second imaging device. The ion source may comprise a housing that may house the enclosure, and one of the imaging devices may be mounted to a top or bottom of the housing, and the other imaging device may be mounted to a side of the housing.

The first view and/or the second view may be aligned with axes of the multi-axis translation stage.

In embodiments, as well the position of the sprayer with respect to the ion inlet being finely adjustable for the purposes of optimising signal strength, e.g. as described above, the sprayer can be more coarsely moved for the purposes of removing/replacing sprayer elements.

Thus, in embodiments, the sprayer is moveable with respect to the ion inlet between at least a first, “inserted” position proximate to the ion inlet that may be suitable for causing ions that may be generated by the sprayer to pass through the ion inlet, and a second, “retracted” position away from the ion inlet that may be suitable for allowing replacement of a replaceable element of the sprayer, e.g. attachment/detachment of the emitter assembly from the manifold assembly. To facilitate this, the multi-axis translation stage may be moveable between different positions corresponding to the first and second positions, and the sprayer may be attached to the multi-axis translation stage. The positioning assembly may comprise one or more bearings, e.g. linear bearing, e.g. rails, configured to guide the sprayer/multi-axis translation stage between the different positions.

Additionally or alternatively, the sprayer may be rotatable between at least a first orientation that may be suitable for causing ions that may be generated by the sprayer to pass through the ion inlet, and a second orientation that may be suitable for allowing replacement of a replaceable element of the sprayer, e.g. attachment/detachment of the emitter assembly from the manifold assembly. In the first orientation, the sprayer/spray may be directed towards the ion inlet, and in the second orientation the sprayer may be directed away from the ion inlet. The positioning assembly may be configured to rotate the sprayer between at least the first orientation and the second orientation. The sprayer may be rotatable between the first orientation and the second orientation when the sprayer is positioned in the second, “retracted”position.

Another aspect comprises an ion source comprising:
a positioning assembly configured to:
move a sprayer between at least a first position for causing ions generated by the sprayer to pass through an ion inlet, and a second position away from the ion inlet; and to:
when the sprayer is positioned in the second position, rotate the sprayer between at least a first orientation in which the sprayer is directed towards the ion inlet, and a second orientation in which the sprayer is directed away from the ion inlet.

These aspects and embodiments can, and in embodiments do, comprise one or more, e.g. all, optional features of other aspects and embodiments described herein, as appropriate.

The positioning assembly may be configured to translate a sprayer between the first, inserted position and the second, retracted position along a first axis. The first axis may be substantially horizontal in normal use. The positioning assembly may be configured to rotate the sprayer between the first orientation and the second orientation about a second axis. The second axis of rotation may be substantially orthogonal to the first axis of translation, such as substantially vertical in normal use.

The multi-axis translation stage may be useable to finely adjust the position of the sprayer when the sprayer is coarsely positioned by the positioning assembly in the first position and first orientation.

In the first orientation, a longitudinal axis of the sprayer may be directed towards the ion inlet, e.g. along the first axis, e.g. the sprayer and ion inlet may be substantially coaxial. In the second orientation, the longitudinal axis of the sprayer may be directed away from the ion inlet, e.g. substantially orthogonal to the first axis e.g. and substantially orthogonal the second axis. The first orientation and the second orientation may differ by ≥10 degrees, such as ≥20 degrees, such as ≥45 degrees, such as ≥80 degrees. The first orientation and the second orientation may differ by about 90 degrees.

The positioning assembly may comprise one or more rotatable bearings, e.g. hinges, configured to guide the sprayer between the different orientations. In embodiments, the sprayer/manifold assembly is attached to the multi-axis translation stage via these one or more rotatable bearings, e.g. hinges. The positioning assembly may comprise an actuator configured to rotate the sprayer/bearing between the different orientations.

The positioning assembly may comprise one or more biasers, e.g. springs, configured to bias the sprayer/bearing towards the second orientation, and a latch configured to hold the sprayer/bearing in the first orientation against the bias of the one or more biasers, e.g. springs. A single user interaction, e.g. button press, may cause the sprayer/bearing to rotate from the first orientation to the second orientation, e.g. by releasing the latch such that the one or more biasers, e.g. springs, cause the sprayer/bearing to rotate to the second orientation.

The positioning assembly may be configured such that a voltage can only be applied to the sprayer by the voltage supply when the sprayer is in the first position and/or the first orientation. To facilitate this, the positioning assembly/bearings may comprise one or more sensors, e.g. microswitches, configured to sense when the sprayer is in the first position and/or the first orientation, and when the sprayer is not in the first position and/or the first orientation, e.g. when the sprayer is in the second position and/or the second orientation.

The ion source may comprise one or more covers for covering elements of the ion source during normal use. The ion source may comprise one or more first controls for controlling the first imaging device, e.g. comprising a focus control for controlling lens focus and/or an aperture control for controlling lens aperture size. The ion source may comprise one or more second controls for controlling the second imaging device, e.g. comprising a focus control for controlling lens focus and/or an aperture control for controlling lens aperture size.

The one or more first controls may be covered by the one or more covers during normal use, and the one or more second controls may be not covered by the one or more covers during normal use. The one or more second controls for controlling the second imaging device may thus be accessible by a user during normal use, and the one or more first controls for controlling the first imaging device may be not accessible by a user during normal use, and e.g. (only) accessible by a service engineer during servicing.

Another aspect comprises a method of operating an ion source as described above. The method may comprise positioning the sprayer/outlet with respect to the ion inlet using a first view provided by the first imaging device, and positioning the sprayer/outlet with respect to the ion inlet using a second, different view provided by the second imaging device.

Accordingly, an aspect comprises a method of operating an ion source that comprises a sprayer, a first imaging device configured to provide a first view of a position of the sprayer with respect to an ion inlet, and a second imaging device configured to provide a second, different view of a position of the sprayer with respect to the ion inlet;
the method comprising:
positioning the sprayer with respect to the ion inlet using a first view of a position of the sprayer with respect to the ion inlet provided by the first imaging device; and
positioning the sprayer with respect to the ion inlet using a second, different view of a position of the sprayer with respect to the ion inlet provided by the second imaging device;
wherein the second view has a higher magnification than the first view.

These aspects and embodiments can, and in embodiments do, comprise one or more, e.g. all, optional features of other aspects and embodiments described herein, as appropriate. For example, the first view may be an overview, and the second view may be a more detailed, e.g. and orthogonal, view, e.g. as described above.

The method may comprise analysing ions generated by the ion source, e.g. by mass analysis and/or ion mobility analysis, such as charge detection mass analysis. The method may comprise positioning the sprayer with respect to the ion inlet using an ion signal from the analysed ions.

The method may be a method of mass spectrometry and/or ion mobility spectrometry, such as a method of charge detection mass spectrometry (CDMS).

Another aspect comprises an ion source comprising:
a positioning assembly configured to position a sprayer with respect to an ion inlet;
a first imaging device configured to provide a first view of a position of the sprayer with respect to the ion inlet; and
a second imaging device configured to provide a second, different view of a position of the sprayer with respect to the ion inlet.

Another aspect comprises a method of operating an ion source that comprises a sprayer, a first imaging device configured to provide a first view of a position of the sprayer with respect to an ion inlet, and a second imaging device configured to provide a second, different view of a position of the sprayer with respect to the ion inlet;
the method comprising:
positioning the sprayer with respect to the ion inlet using a first view of a position of the sprayer with respect to the ion inlet provided by the first imaging device; and
positioning the sprayer with respect to the ion inlet using a second, different view of a position of the sprayer with respect to the ion inlet provided by the second imaging device.

Another aspect comprises an ion source comprising a positioning assembly configured to rotate a sprayer between at least a first orientation in which the sprayer is directed towards an ion inlet, and a second orientation in which the sprayer is directed away from the ion inlet.

These aspects and embodiments can, and in embodiments do, comprise one or more, e.g. all, optional features of other aspects and embodiments described herein, as appropriate.

### BRIEF DESCRIPTION OF THE DRAWINGS

Various embodiments will now be described, by way of example only, and with reference to the accompanying drawings in which:

FIG. 1 shows an analytical instrument in accordance with embodiments;

FIG. 2 shows a charge detection mass analyser in accordance with embodiments;

FIG. 3 shows an electrospray ionisation (ESI) ion source in accordance with embodiments;

FIG. 4A shows an ESI sprayer in accordance with embodiments, and FIG. 4B shows an ESI ion source comprising the ESI sprayer in accordance with embodiments;

FIG. 5A, FIG. 5B and FIG. 5C show an ESI ion source in accordance with embodiments;

FIG. 6 shows an imaging device in accordance with embodiments;

FIG. 7 shows a section view of an ESI ion source in accordance with embodiments;

FIG. 8A and FIG. 8B show to different views provided by two different imaging devices in accordance with embodiments;

FIG. 9 shows a process for aligning a sprayer with respect to an ion inlet, in accordance with embodiments; and

FIG. 10 shows an ESI ion source having one or more covers in accordance with embodiments.

### DETAILED DESCRIPTION

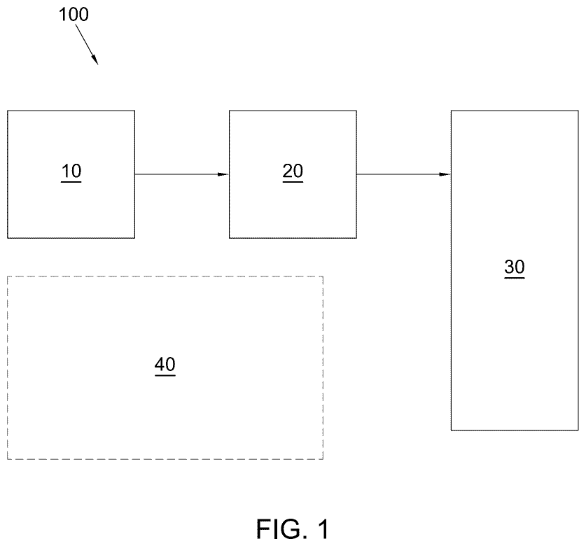

FIG. 1 shows schematically an analytical instrument 100 in accordance with various embodiments. As shown in FIG. 1, the analytical instrument 100 comprises an ion source 10, one or more functional components 20 that are arranged downstream from the ion source 10, and an analyser 30 that is arranged downstream from the ion source 10 and from the one or more functional components 20.

It should be noted that FIG. 1 is merely schematic, and that the analytical instrument 100 may, and in various embodiments does, include other components, devices and functional elements to those shown in FIG. 1.

The ion source 10 is configured to generate ions by ionising an analyte. The analytical instrument 100 may optionally comprise a chromatography or other separation device (not shown in FIG. 1) upstream of and coupled to the ion source 10.

The analyser 30 is configured to analyse ions so as to determine (measure) one or more of their physical or chemical properties, such as their mass, charge, mass to charge ratio, time of flight, ion mobility drift time and/or collision cross section (CCS), differential ion mobility, etc. The analyser 30 may comprise a mass analyser that may be configured to determine the mass to charge ratio or time of flight of ions and/or an ion mobility analyser that may be configured to determine the ion mobility drift time or collision cross section (CCS) or differential ion mobility of ions. The mass analyser may, for example, comprise a quadrupole mass analyser, a Time of Flight mass analyser, a linear ion trap mass analyser, or a charge detection mass analyser.

As shown in FIG. 1, the analytical instrument 100 comprises a control system 40, that may be configured to control the operation of the analytical instrument 100, for example in the manner of the various embodiments described herein. The control system 40 may comprise suitable control circuitry that is configured to cause the instrument to operate in the manner of the various embodiments described herein. In various embodiments, the control system 40 may comprise a suitable computing device, a microprocessor system, a programmable FPGA (field programmable gate array), and the like. In various embodiments, the control system comprises storage, e.g. a memory, for storing information and instructions for performing methods described herein.

As illustrated by FIG. 1, the analytical instrument 100 is configured such that ions can be provided by the ion source 10 to the analyser 30 via the one or more functional components 20. The one or more functional components 20 may comprise any suitable such components, devices and functional elements of an analytical instrument, e.g. mass and/or ion mobility spectrometer.

In various embodiments, the ion source 10 operates at a higher pressure than the analyser 30. For example, the analyser 30 operates at high vacuum and the ion source 10 operates at low vacuum or at substantially atmospheric pressure. The one or more functional components 20 may comprise one or more, e.g. a series of, vacuum stages for reducing and maintaining the desired pressures.

In various embodiments, the one or more functional components 20 comprise one or more ion guides and/or one or more ion traps. In various embodiments, the one or more functional components 20 comprise a mass filter, which may be configured to filter ions according to their mass to charge ratio. In various embodiments, the one or more functional components 20 comprise an activation, collision, fragmentation or reaction device configured to activate, fragment or react ions. In various embodiments, the one or more functional components 20 comprise an ion mobility separator configured to separate ions according to their ion mobility.

Other functional components 20 would be possible.

In various embodiments, the analytical instrument 100 is a charge detection mass spectrometer and the analyser 30 is a charge detection mass analyser configured to determine the charge and mass to charge ratio of ions.

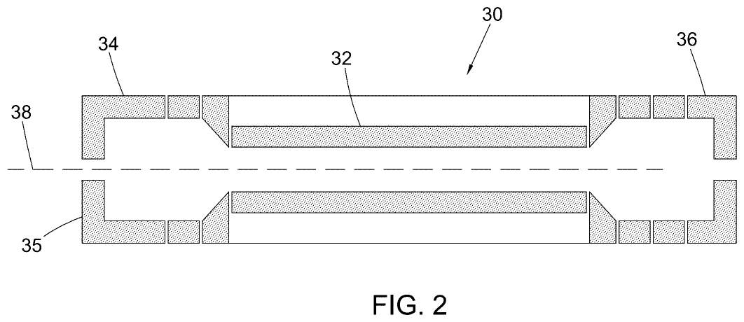

FIG. 2 shows a schematic of a charge detection mass analyser 30 in accordance with embodiments. As shown in FIG. 2, the analyser 30 comprises a charge detector 32 arranged between a first reflectron or ion mirror 34 and a second reflectron or ion mirror 36. In use, ions 38 to be analysed pass through an end cap 35 of the first reflectron 34, and then oscillate between the reflectrons 34, 36, and therefore through the charge detector 32, at a frequency that is related to mass to charge ratio. Each time an ion passes through charge detector 32, it induces an electrical charge on the detector 32. The mass to charge ratio of an ion is determined from the frequency at which charge is induced on the charge detector 32, and the charge of the ion is determined from the amplitude of the charge that is induced on the charge detector 32. The mass of the ion may be determined by multiplying the detected mass to charge ratio by the detected charge of the ion. Multiple different ions may be analysed simultaneously by deconvolving respective signals induced on the charge detector 32 by the different ions.

Charge detection mass spectrometry (CDMS) is a useful technique that enables, for example, the characterisation of large, highly-charged and heterogeneous analytes, such as whole virus capsids, that are of increasing importance in biotherapeutics. To effectively ionise such analytes, an electrospray ionisation (ESI) ion source may be used.

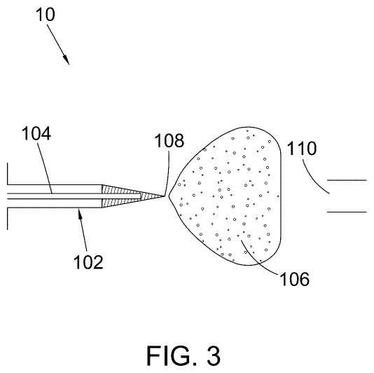

FIG. 3 shows schematically an electrospray ionisation (ESI) ion source 10 in accordance with embodiments. As shown in FIG. 3, the ion source 10 comprises an emitter 102 comprising an internal capillary 104 that, in use, will emit charged droplets 106 of a sample via an electrospray process when the sample is provided to an outlet orifice 108 of the capillary 104 and the sample is electrified.

The outlet orifice 108 is located at an outlet end of the emitter 102 and may be sized to allow the emitter 102 to be suitable for use in a nano electrospray ionisation (NanoESI) process. For example, a diameter of the outlet orifice 108 at the downstream end may be less than 100 μm, less than 50 μm, or less than 25 μm, such as between 0.1 μm and 20 μm.

In use, a meniscus of the sample can form extending out of the capillary 104 at the outlet orifice 108, e.g. in the form of a Taylor cone, and electrostatic stress within the sample resulting from its electrification can cause charged droplets 106 to be emitted from the meniscus. Successively smaller droplets may then be created from the charged droplets, e.g. by evaporation of the sample causing the droplets to decrease in size and burst into smaller droplets as a result of increasing electrostatic forces within the charged droplets 106 as they decrease in size. This process can lead to gaseous phase ions emitted from the droplets being obtained for use, e.g. by entering an inlet 110 of the analytical instrument for analysis.

Any suitable voltage for electrospraying a particular sample may be used. In embodiments, a voltage greater than 100 V is supplied to the sample to electrospray it. For example, the voltage may be between 100 V and 10 kV, such as between 200 V and 4.5 kV, such as about 3 kV.

The electrospraying process occurs in an ESI sprayer chamber (not shown in FIG. 3) that contains the ion inlet 110 to the spectrometer. FIG. 3 shows a tubular ion inlet 110, but other ion inlet aperture geometries are possible, such as conical.

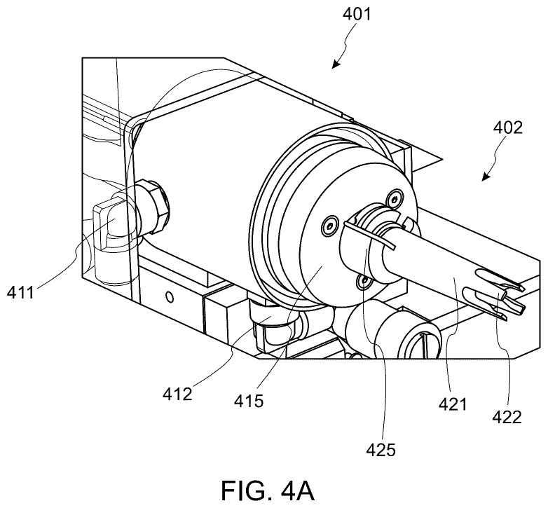

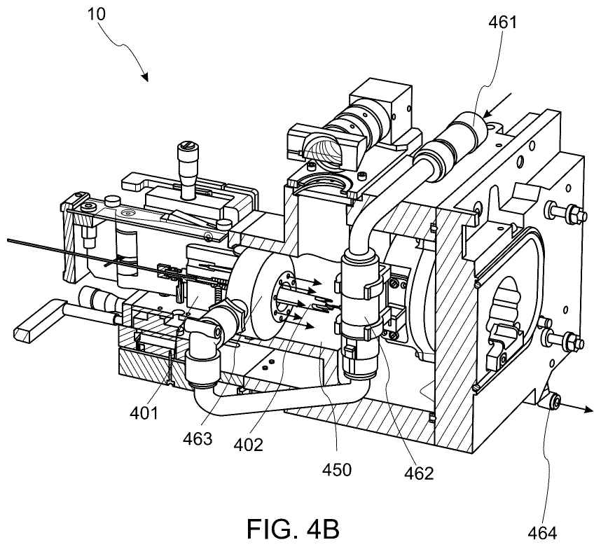

FIG. 4A shows in more detail an ESI sprayer according to an embodiment, in which electrospray emitter assembly 402 is removably attachable to electrospray manifold assembly 401. This allows the electrospray emitter assembly 402 to be easily replaced, e.g. if blocked or damaged, or to allow a different electrospray emitter assembly with different characteristics/parameters, e.g. different outlet orifice diameter, to be used.

As shown in FIG. 4A, the electrospray emitter assembly 402 includes a connector element 425 which is removably attachable to a corresponding connector element 415 of the manifold assembly 401 by bayonet-style connection. Other fastening mechanisms, such as press-fit, snap-fit, threaded connection, etc. are possible.

As shown in FIG. 4A, the manifold assembly 401 further comprises conduits 411, 412 for supplying and/or draining sprayer fluids. The electrospray emitter assembly 402 comprises a sheath electrode 421 that surrounds ESI emitter/capillary 102 (not shown in FIG. 4A). In the present embodiment, sheath electrode 421 includes prongs 422 that can act as a counter electrode and cause sample to be electrosprayed from the capillary 102. Other arrangements are possible.

FIG. 4B shows in more detail an ESI ion source 10 according to the present embodiment. FIG. 4B shows the electrospray emitter assembly 402 located within a sprayer chamber 450 of the ion source 10, such that electrospray emitter 402 can generate a spray of charged droplets within sprayer chamber 450.

In the present embodiment, ion source 10 further comprises a gas flow system that can generate a flow of gas through sprayer chamber 450. The gas flow system includes an air intake 461. Air entering air intake 461 is filtered by in-line filter 462, and the filtered air is introduced into the sprayer chamber 450 by gas manifold 463. The filtered air passes through the sprayer chamber 450 and leaves the sprayer chamber 450 through outlet 464. The flow of gas provided by the gas flow system can vent excess spray from the sprayer chamber 450. However, the gas flow system is not essential, and may be omitted in other embodiments.

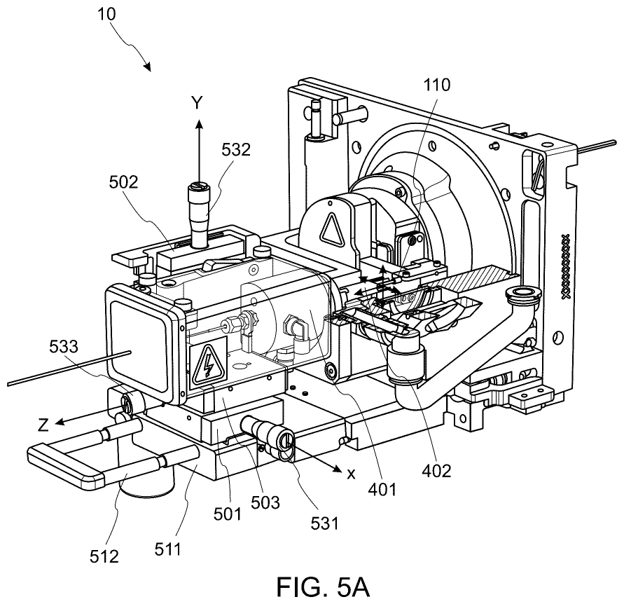

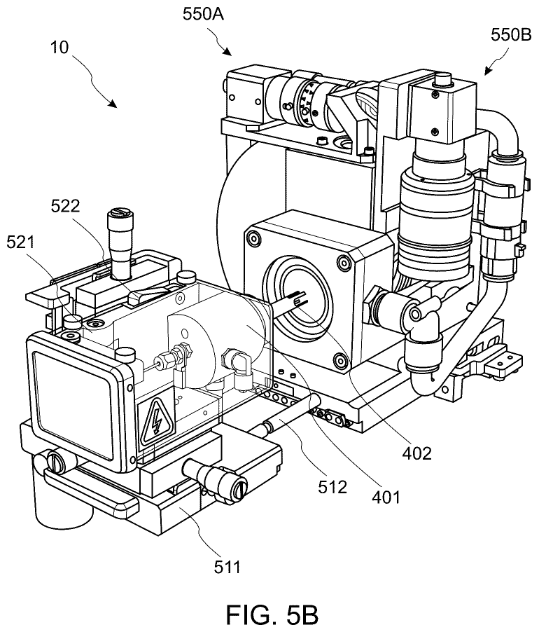

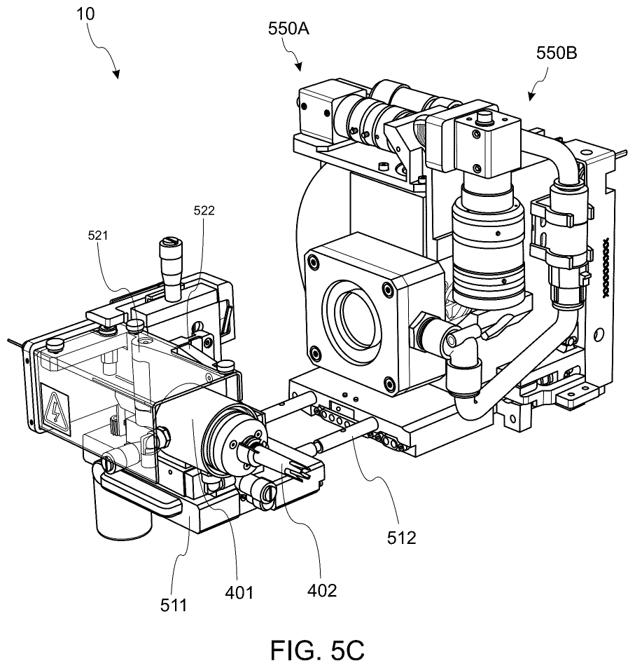

FIG. 5A shows another view of the ESI ion source 10 of the present embodiment, in which the electrospray emitter 402 is positioned within the sprayer chamber 450 to provide ions towards spectrometer inlet 110. As shown in FIG. 5A, the electrospray manifold assembly 401 is mounted to a three-axis translation stage that includes X, Y and Z linear positioning stages 501, 502, 503. The three-axis translation stage allows fine adjustment of the position of the electrospray emitter assembly 402 with respect to the ion inlet 110 in three dimensions: along a Z-axis which is parallel to a longitudinal axis of the ion inlet 110, and X and Y axes which are orthogonal to the Z-axis and to each other. This allows the position of the electrospray emitter 402 with respect to the ion inlet 110 to be optimised, e.g. so as to optimise signal strength.

In the present embodiment, X, Y and Z linear positioning stages 501, 502, 503 are each provided with a respective thimble 531, 532, 533 that can be rotated by a user to finely adjust the position of the sprayer 402. Other arrangements are possible.

To facilitate replacement of the electrospray emitter assembly 402, the three-axis translation stage is mounted to a retractable base 511 which is movable in the Z direction along rails 512 between a first position shown in FIG. 5A, in which the electrospray emitter assembly 402 is positioned within the sprayer chamber 450 proximate the ion inlet 110 for use, and a second position shown in FIG. 5B, in which the electrospray emitter assembly 402 is retracted out of the sprayer chamber 450 (away from the ion inlet 110).

As can best be seen in FIGS. 5B and 5C, the electrospray manifold assembly 401 is mounted to the three-axis translation stage by a hinge assembly 521 that allows the manifold assembly 401, and electrospray emitter assembly 402 connected thereto, to rotate through 90 degrees from a first orientation shown in FIG. 5B, in which a longitudinal axis of the electrospray emitter 402 is substantially parallel to the Z-axis, to a second orientation shown in FIG. 5C, in which the longitudinal axis of the electrospray emitter assembly 402 is substantially parallel to the X-axis. The inventors have found that a retracted and rotated position and orientation such as is shown in FIG. 5C is particularly convenient for replacement of the electrospray emitter assembly 402.

In the present embodiment, the hinge assembly 521 includes a spring, or other biaser, that biases the hinge assembly 521 to the second orientation (shown in FIG. 5C), and a latch that can hold the hinge assembly 521 in the first orientation (shown in FIG. 5B) against the bias of the spring. Rotating the hinge assembly 521 from the second orientation to the first orientation causes the spring to be energised and the latch to be engaged. A single push of button 522 can then release the latch, such that the energised spring causes hinge assembly 521 to spring open from the first orientation (shown in FIG. 5B), to the second orientation (shown in FIG. 5C). The hinge assembly 521 may further comprise one or more magnets to hold the hinge assembly 521 in the second orientation.

In the present embodiment, the retractable base 511 and hinge assembly 521 include microswitches that act as safety interlocks, such that a voltage can only be applied to the electrospray emitter 402 when the microswitches indicate that the electrospray emitter 402 is positioned in the first position and orientation (shown in FIG. 5A) within the sprayer chamber 450. This can reduce the risk of electric shock when replacing the electrospray emitter 402.

As discussed above, when the electrospray emitter 402 is (coarsely) positioned in the first position and orientation (shown in FIG. 5A) within the sprayer chamber 450, three-axis translation stage 501-503 can be used to (finely) adjust the position of the electrospray emitter 402 with respect to the ion inlet 110 so as to optimise signal strength. Typically, this process involves adjusting each of the X, Y and Z stages 501-503 while monitoring a strength of signal detected by the analyser 30, to try to locate an emitter position that corresponds to a signal maximum. The inventors have found, however, that this process can be difficult and time consuming, and may result in sub-optimal emitter positioning.

As can be seen in FIGS. 5B and 5C, in embodiments of the technology described herein, to assist with positioning the electrospray emitter assembly 402 with respect to the ion inlet 110, the ESI ion source 10 is provided with a pair of orthogonal imaging devices (cameras) 550A, 550B. Each imaging device is configured to provide a, e.g. real-time, view into the sprayer chamber 450 in the vicinity of the ion inlet 110, and can thus be used to view the position of the electrospray emitter 402 with respect to the ion inlet 110 when adjusting the position of the electrospray emitter 402 with respect to the ion inlet 110.

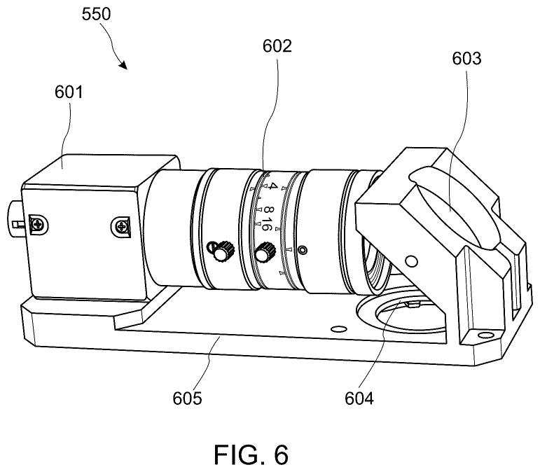

FIG. 6 shows an imaging device (camera) 550 in accordance with the present embodiment. As shown in FIG. 6, the imaging device 550 includes an image sensor 601, a lens 602 and a light source 604 for illuminating the vicinity of the ion inlet 110. Lens 602 includes a focus ring for adjusting focus, and an aperture ring for adjust aperture size. In the present embodiment, the light source 604 comprises a ring of LEDs, with the optical path of the imaging device (camera) passing through the ring. To provide a more compact form, the optical path is bent through a 90-degree angle by mirror 603. The imaging device (camera) 550 further comprises a mounting plate 605 for mounting the device to the ion source 10.

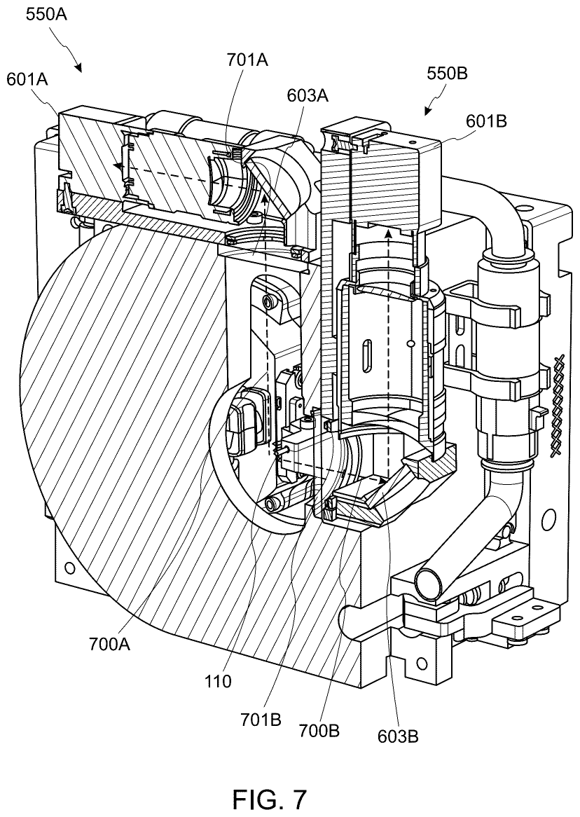

FIG. 7 is a section view of the pair of imaging devices 550A, 550B mounted to the ion source 10 in accordance with the present embodiment. The ion source housing comprises windows 701A, 701B through which the imaging devices 550A, 550B can illuminate the vicinity of the ion inlet 110 and obtain images thereof. The imaging devices 550A, 550B are mounted orthogonally to each other such that the imaging devices 550A, 550B provide orthogonal views into the sprayer chamber 450 in the vicinity of the ion inlet 110.

As illustrated in FIG. 7, optical path 700A of top-mounted imaging device 550A passes between image sensor 601A and mirror 603A substantially parallel to the X axis, and passes between mirror 603A and the vicinity of the ion inlet 110 through window 701A substantially parallel to the Y axis, such that top-mounted imaging device 550A provides an X-Z plane view of the vicinity of the ion inlet 110.

Optical path 700B of side-mounted imaging device 550B passes between image sensor 601B and mirror 603B substantially parallel to the Y axis, and passes between mirror 603B and the vicinity of the ion inlet 110 through window 701B substantially parallel to the X axis, such that side-mounted imaging device 550B provides a Y-Z plane view of the vicinity of the ion inlet 110. The imaging devices 550A, 550B thus provide orthogonal views of the position of the electrospray emitter 402 with respect to the ion inlet 110.

The imaging devices (cameras) 550A, 550B could have the same magnification/field of view. However, in the present embodiment, top-mounted imaging device 550A is configured to provide an overview of the vicinity of the ion inlet 110, and side-mounted imaging device 550B is configured to provide a more detailed view by having higher magnification. Alternatively, side-mounted imaging device 550B could provide an overview, and top-mounted imaging device 550A could provide a more detailed view.

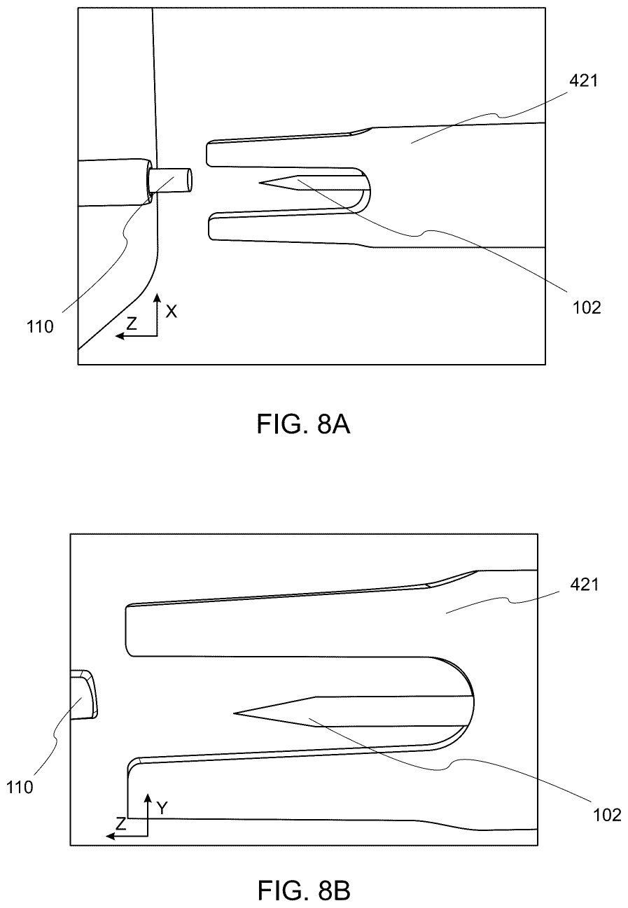

For example, FIG. 8A shows an X-Z plane overview, lower magnification, image obtained by top-mounted imaging device (camera) 550A, and FIG. 8B shows a Y-Z plane detailed view, higher magnification, image obtained by side-mounted imaging device (camera) 550B, in accordance with embodiments. The overview image (shown in FIG. 8A) has a wider field of view than the detailed view (shown in FIG. 8B), and thus the overview image can be used to relatively coarsely position the emitter 102 with respect to the ion inlet 110, and the detailed view can be used to finely adjust the position of the emitter 102 with respect to the ion inlet 110. This can improve the ease and accuracy of positioning the emitter with respect to the ion inlet 110.

FIG. 8 shows still views (images) obtained by imaging devices 550A, 550B, but it will be appreciated that the imaging devices 550A, 550B may obtain moving views, i.e. video. Images obtained by imaging devices 550A, 550B may be displayed on a suitable display.

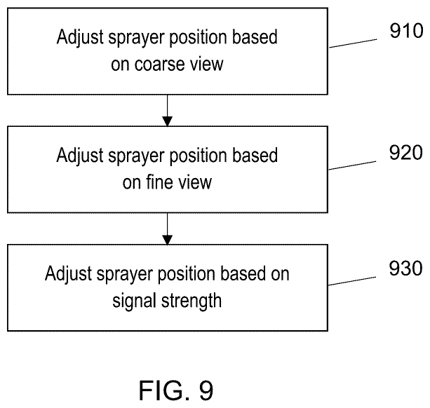

FIG. 9 shows a process for positioning electrospray emitter 102, 402 with respect to ion inlet 110 in accordance with the present embodiment. As shown in FIG. 9, a lower magnification view provided by overview camera 550A is used (at step 910) to relatively coarsely position the emitter 102 with respect to the ion inlet 110. The lower magnification view may be a X-Z plane view, and thus step 910 may comprise adjusting the position the emitter 102 predominantly in the X and Z directions.

Then, once the emitter 102 has been positioned in a relatively coarse manner, the higher magnification view provided by detailed view camera 550B is used (at step 920) to make finer adjustments to the position of the emitter 102 with respect to the ion inlet 110. The higher magnification view may be a Y-Z plane view, and thus step 920 may comprise adjusting the position the emitter 102 predominantly in the Y and Z directions.

Even finer adjustments to the position of the emitter 102 with respect to the ion inlet 110 may then be made (at step 930) based on a strength of signal detected by the analyser 30. Step 930 may comprise adjusting the position the emitter 102 in the X, Y and Z directions.

In other embodiments, steps 910, 920, 930 may be performed in a different order and/or two or more of the steps may be performed at least partially simultaneously.

FIG. 10 shows another view of ion source 10 in accordance with an embodiment. FIG. 10 shows ion source 10 provided with a number of covers that cover and enclose various components of the ion source during normal use. As shown in FIG. 10, user controls, including translation stage thimbles 531, 532, 533 and button 522, extend through the covers to allow user access during normal use.

As shown in FIG. 10, the covers include a top cover 1001A that covers top-mounted overview camera 550A (not visible in FIG. 10), and a side cover 1001B that covers side-mounted detail camera 550B (not visible in FIG. 10).

In the present embodiment, the controls for the top-mounted overview camera 550A (e.g. focus ring and aperture ring) are concealed by the top cover 1001A, and do not extend through the covers to allow user access during normal use. Rather, top cover 1001A must be opened, e.g. by a service engineer during servicing, in order to access the controls for the top-mounted overview camera 550A (e.g. focus ring and aperture ring).

Controls for the side-mounted detail camera 550B, however, do extend through side cover 1001B to allow user access during normal use. As illustrated in FIG. 10, an aperture control 1002 is provided for adjusting the aperture ring of the detail camera 550B, and a focus control 1003 is provided for adjusting the focus ring of the detail camera 550B. Other controls would be possible.

This arrangement can allow a user to adjust the detail camera 550B during normal use, while avoiding inadvertent adjustments to the overview camera 550A, which will typically require much less frequent adjustment than the detail camera 550B.

Although embodiments comprising two imaging devices have been described, other embodiments may comprise three or more imaging devices.

Although embodiments have been described with particular reference to electrospray ionisation (ESI), other embodiments relate to other ionisation techniques that generate a spray of sample. Similarly, although embodiments have been described with particular reference to a charge detection mass spectrometer, other embodiments relate to other types of mass spectrometer or analytical instrument, such as an ion mobility spectrometer.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. An ion source comprising:
a positioning assembly configured to position a sprayer with respect to an ion inlet;
a first imaging device configured to provide a first view of a position of the sprayer with respect to the ion inlet; and
a second imaging device configured to provide a second, different view of a position of the sprayer with respect to the ion inlet;
wherein the second view has a higher magnification than the first view.

2. The ion source of claim 1, wherein the first view and the second view are substantially orthogonal to each other.

3. The ion source of claim 1, comprising:
one or more covers;
one or more first controls for adjusting the first view; and
one or more second controls for adjusting the second view;
wherein the one or more first controls are covered by the one or more covers; and
wherein the one or more second controls are not covered by the one or more covers.

4. The ion source of claim 1, wherein the positioning assembly comprises a multi-axis translation stage, and the first view and the second view are aligned with axes of the multi-axis translation stage.

5. The ion source of claim 1, wherein the first and/or second imaging device comprises a mirror configured to turn an optical path of the imaging device through about 90 degrees.

6. The ion source of claim 1, wherein the positioning assembly is configured to rotate the sprayer between at least a first orientation in which the sprayer is directed towards the ion inlet, and a second orientation in which the sprayer is directed away from the ion inlet.

7. An ion source comprising:
a positioning assembly configured to:
move a sprayer between at least a first position for causing ions generated by the sprayer to pass through an ion inlet, and a second position away from the ion inlet; and to:
when the sprayer is positioned in the second position, rotate the sprayer between at least a first orientation in which the sprayer is directed towards the ion inlet, and a second orientation in which the sprayer is directed away from the ion inlet.

8. The ion source of claim 6, wherein the first orientation and the second orientation differ by about 90 degrees.

9. The ion source of claim 6, wherein the positioning assembly is configured to rotate the sprayer between the first orientation and the second orientation in response to a single user interaction.

10. The ion source of claim 6, comprising a voltage supply configured to supply a voltage to the sprayer;
wherein the ion source is configured such that the voltage supply can only supply a voltage to the sprayer when the sprayer is in the first orientation.

11. The ion source of claim 1, wherein the sprayer comprises:
a manifold assembly that is attached to the positioning assembly; and
an emitter assembly that is removably attached to the manifold assembly.

12. The ion source of claim 1, wherein the ion source is an electrospray ionisation (ESI) ion source.

13. An analytical instrument comprising the ion source of claim 1.

14. The analytical instrument of claim 13, wherein the analytical instrument is a mass spectrometer, ion mobility spectrometer or charge detection mass spectrometer.

15. A method of operating an ion source that comprises a sprayer, a first imaging device configured to provide a first view of a position of the sprayer with respect to an ion inlet, and a second imaging device configured to provide a second, different view of a position of the sprayer with respect to the ion inlet;
the method comprising:
positioning the sprayer with respect to the ion inlet using a first view of a position of the sprayer with respect to the ion inlet provided by the first imaging device; and
positioning the sprayer with respect to the ion inlet using a second, different view of a position of the sprayer with respect to the ion inlet provided by the second imaging device;
wherein the second view has a higher magnification than the first view.
